(19) United States
(12) Patent Application Publication
(10) Pub. No.: US 2024/0233614 A1
(43) Pub. Date: Jul. 11, 2024

(54) WAVEGUIDE CORRECTION

(71) Applicant: Meta Platforms Technologies, LLC, Menlo Park, CA (US)

(72) Inventors: Edward Buckley, High Peak (GB); Christopher Francis Reidy, Bellevue, WA (US)

(21) Appl. No.: 18/152,591

(22) Filed: Jan. 10, 2023

(51) Int. Cl. G09G 3/32; G02B 27/01; G06F 3/01; G09G 3/02

(52) U.S. Cl. CPC G09G 3/32; G02B 27/0172; G06F 3/013; G09G 3/025; G02B 2027/011; G09G 2320/0233; G09G 2320/0242; G09G 2320/0666; G09G 2354/00; G09G 2360/16

(57) ABSTRACT

In one embodiment, a computing system may access an image to be displayed on a display through a waveguide. The system may access an array of correction factors for pixel values of the image. The array of correction factors, once applied to the pixel values of the image, may correct a chrominance error associated with the image. The array of correction factors may be determined based at least on two chrominance components corresponding to a transmission character of the waveguide in an opponent color space. The system may adjust the pixel values of the image based on the array of correction factors. The system may output the image with the adjusted pixel values to the display through the waveguide.

### TECHNICAL FIELD

This disclosure generally relates to artificial reality, such as virtual reality and augmented reality.

### BACKGROUND

Artificial reality is a form of reality that has been adjusted in some manner before presentation to a user, which may include, e.g., a virtual reality (VR), an augmented reality (AR), a mixed reality (MR), a hybrid reality, or some combination and/or derivatives thereof. Artificial reality content may include completely generated content or generated content combined with captured content (e.g., real-world photographs). The artificial reality content may include video, audio, haptic feedback, or some combination thereof, and any of which may be presented in a single channel or in multiple channels (such as stereo video that produces a three-dimensional effect to the viewer). Artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, or any other hardware platform capable of providing artificial reality content to one or more viewers.

### SUMMARY OF PARTICULAR EMBODIMENTS

Particular embodiments described herein relate to a method of using an optimization process, which trades off the luminance and chrominance errors, to calculate optimized correction factors which can be used to adjust image pixel values to correct waveguide non-uniformity. The optimization process may be subject to an upper and lower bound corresponding to the clipping factor which corresponds to a maximum to minimum ratio as limited by the uLEDs performance limitation. The system may incorporate the clipping factor by subjecting the optimization process to a pre-determined range for the correction factor values as determined by the clipping factor. The correction factors may be included in a correction map or mask, which can be stored in a computer storage and retrieved at runtime to adjust pixel values of images to correct the waveguide non-uniformity before the images are displayed. To generate the pre-computed correction map or mask, the system may first measure the waveguide transmission characters in the tristimulus color space (X, Y, Z). Then, the system may convert the waveguide tristimulus transmission into an opponent color space (L, O₁, O₂). After that, the system may use the optimizer to compute the correction factor values that minimize the chrominance or/and luminance errors, as weighted by the weighting parameter.

In one embodiment, the system may perform the optimization process by taking into consideration all three dimensions of (L, O₁, O₂) in the opponent color space. As a result, the optimization process may minimize both the luminance and chrominance errors at the same time. In another embodiment, the system may perform the optimization process by only considering two dimensions (O₁, O₂) of the opponent color space to minimize only the chrominance error, leaving the luminance error uncorrected. The resulting images may have improved chrominance correction results but may have visual artifacts in the luminance dimension. In yet another embodiment, the optimization process may trade off the luminance error and the chrominance error using a weighting parameter in the optimization process. The weighting parameter may weight the luminance component (L) against the two chrominance components (O₁ and O₂) based on its value. A greater value for the weighting parameter may allow the system to reduce the luminance errors by a higher degree (and, accordingly, reduce the chrominance errors by a lower degree), and thus to have more accurate colors but less accurate luminance. For example, a weighting parameter of 1 may allow the luminance error and chrominance error to be weighted equally and allow the system to minimize the luminance error to the same extent as to the chrominance error. On the other hand, a smaller value for the weighting parameter may reduce the chrominance errors to a higher degree and accordingly reduce the luminance error to a lower degree. For example, the weighting parameter value of 0 may allow the system to only minimize the chrominance errors, leaving the luminance error uncorrected. The system may use a second optimization process to determine an optimized weighting parameter value for trading off the luminance and the chrominance errors. In some embodiments, each color channel of the RGB color channels may use the same weighting parameter value. In some other embodiments, each color channel may use a different weighting parameter value. The system may determine the optimized weighting value(s) based on the display quality of the corrected images (e.g., the chrominance errors and luminance errors as perceived by viewers). Using the optimization process, the system may determine the optimized correction factor value for each pixel of the image to be displayed. The system may repeat this process to determine a correction map or correction mask, which includes all the correction factors for all pixels of the display. Then, the system may store the pre-computed correction map or mask in a computer storage. At runtime, the system may retrieve the correction map or mask from the computer storage and apply it to the images to be displayed to adjust the pixel values of the images. The images with the adjusted pixel values based on the correction factors, once displayed, may have less chrominance or/and luminance errors as perceived by the viewer. In some embodiments, the correction factors may be customized based on the viewer's eye position with respect to a number of pre-determined positions associated with an eye box of the viewer.

The embodiments disclosed herein are only examples, and the scope of this disclosure is not limited to them. Particular embodiments may include all, some, or none of the components, elements, features, functions, operations, or steps of the embodiments disclosed above. Embodiments according to the invention are in particular disclosed in the attached claims directed to a method, a storage medium, a system and a computer program product, wherein any feature mentioned in one claim category, e.g. method, can be claimed in another claim category, e.g. system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

### BRIEF DESCRIPTION OF THE DRAWINGS

FIG. 1A illustrates an example artificial reality system.

FIG. 1B illustrates an example augmented reality system.

FIG. 1C illustrates an example architecture of a display engine.

FIG. 1D illustrates an example graphic pipeline of the display engine for generating display image data.

FIG. 2A illustrates an example scanning waveguide display.

FIG. 2B illustrates an example scanning operation of the scanning waveguide display.

FIG. 3A illustrates an example 2D micro-LED waveguide display.

FIG. 3B illustrates an example waveguide configuration for the 2D micro-LED waveguide display.

FIG. 4 illustrates an example calculation process for determining waveguide correction factors in the tristimulus color space.

FIG. 5 illustrates an example optimization process of determining the correction factors for correcting both luminance and chrominance errors.

FIG. 6 illustrates an example optimization process of determining the correction factors for correcting chrominance errors.

FIG. 7 illustrates an example optimization process of determining the correction factors by trading off the corrections of the chrominance and luminance errors

FIG. 8 illustrates an example method for adjusting pixel values of an image based on correction factors to reduce chrominance errors of the image.

FIG. 9 illustrates an example computer system.

### DESCRIPTION OF EXAMPLE EMBODIMENTS

The number of available bits in a display may limit the display's color depth or gray scale levels. To achieve display results with higher effective grayscale level, displays may use a series of temporal subframes with less grayscale level bits to create the illusion of a target image with more grayscale level bits. The series of subframes may be generated using a segmented quantization process with each segment having a different weight. The quantization errors may be dithered spatially within each subframe. However, the subframes generated in this way may have a naïve stacking property (e.g., direct stacking property without using a dither mask) and each subframe may be generated without considering what has been displayed in former subframes causing the subframes to have some artifacts that could negatively impact the experience of the viewers.

In particular embodiments, the system may use a mask-based spatio-temporal dithering method for generating each subframe of a series of subframes taking into consideration what has been displayed in the previous subframes preceding that subframe. The system may determine target pixel values of current subframe by compensating the quantization errors of the previously subframes. The pixel values of the current subframe may be determined by quantizing the target pixel values based on a dither mask having a spatial stacking property. The quantization errors may be propagated into subsequent subframes through an error buffer. The generated subframes may satisfy both spatial and temporal stacking property and provide better image display results and better user experience.

Particular embodiments of the system may provide better image quality and improve user experience for AR/VR display by using multiple subframe images with less color depth to represent an image with greater color depth. Particular embodiments of the system may generate subframe images with reduced or eliminated temporal artifacts. Particular embodiments of the system may allow AR/VR display system to reduce the space and complexity of pixel circuits by having less gray level bits, and therefore miniaturize the size of the display system. Particular embodiments of the system may make it possible for AR/VR displays to operate in monochrome mode with digital pixel circuits without using analog pixel circuits for full RGB operations.

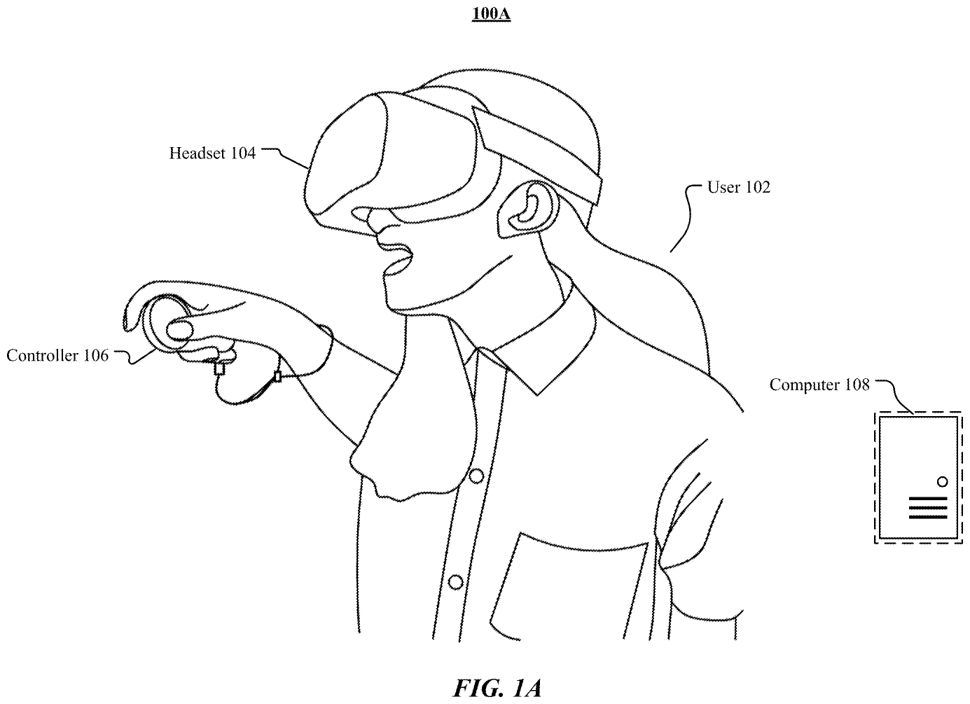

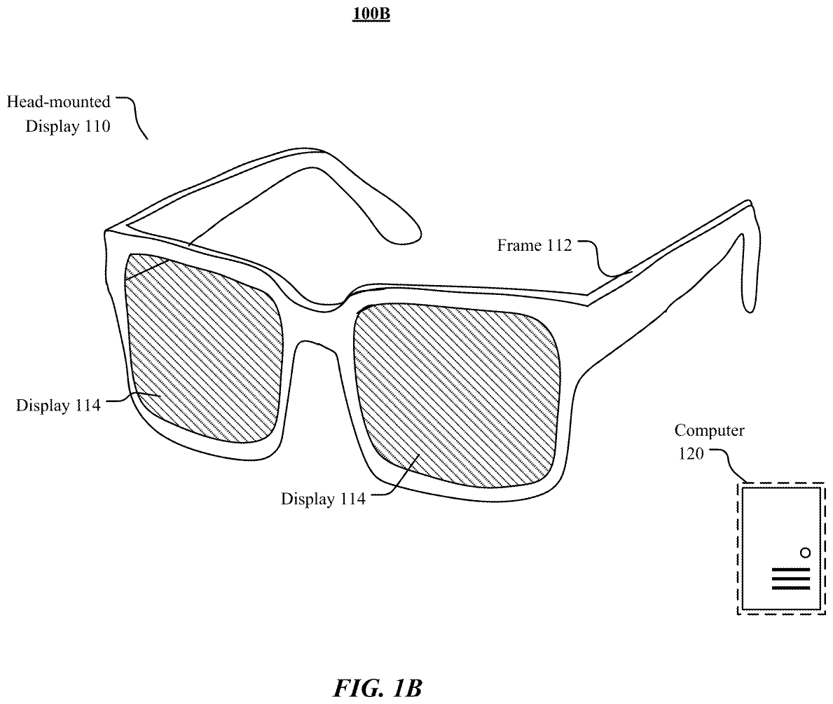

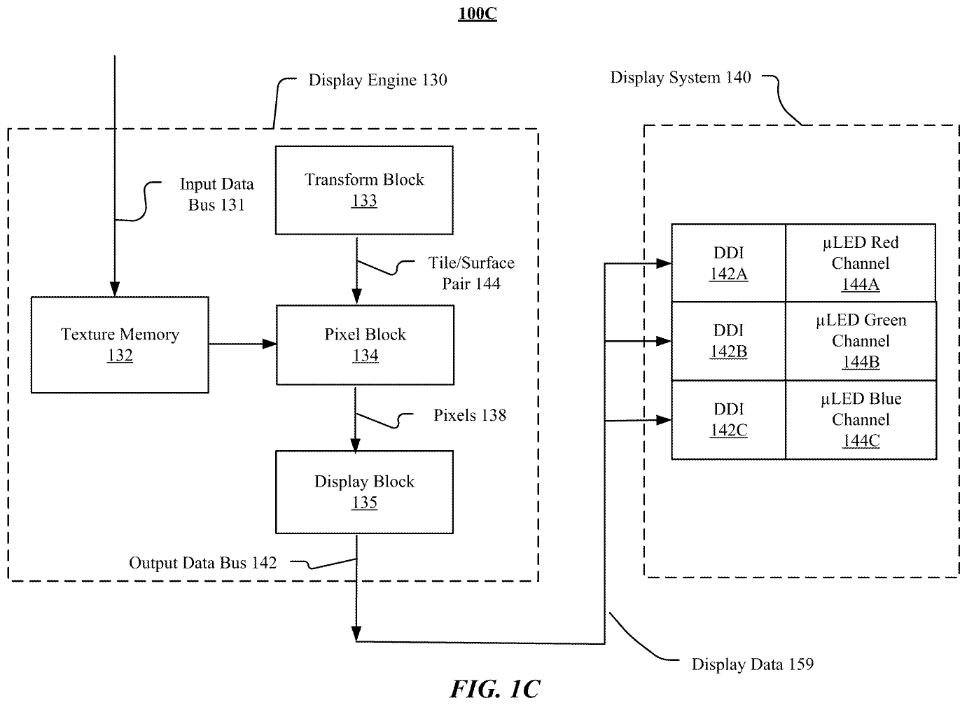

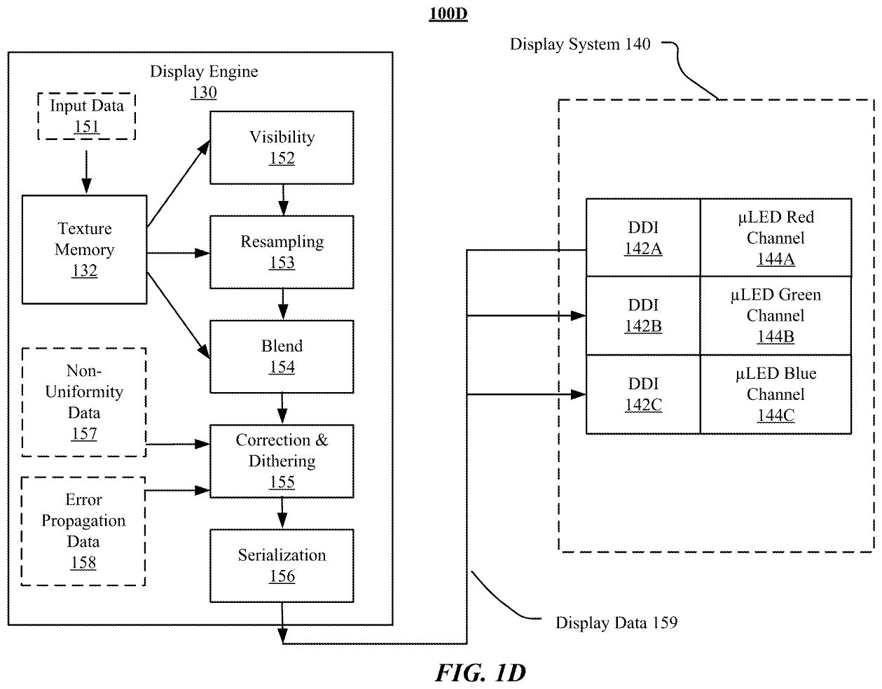

FIG. 1A illustrates an example artificial reality system 100A. In particular embodiments, the artificial reality system 100 may comprise a headset 104, a controller 106, and a computing system 108. A user 102 may wear the headset 104 that may display visual artificial reality content to the user 102. The headset 104 may include an audio device that may provide audio artificial reality content to the user 102. The headset 104 may include one or more cameras which can capture images and videos of environments. The headset 104 may include an eye tracking system to determine the vergence distance of the user 102. The headset 104 may be referred as a head-mounted display (HDM). The controller 106 may comprise a trackpad and one or more buttons. The controller 106 may receive inputs from the user 102 and relay the inputs to the computing system 108. The controller 206 may also provide haptic feedback to the user 102. The computing system 108 may be connected to the headset 104 and the controller 106 through cables or wireless connections. The computing system 108 may control the headset 104 and the controller 106 to provide the artificial reality content to and receive inputs from the user 102. The computing system 108 may be a standalone host computer system, an on-board computer system integrated with the headset 104, a mobile device, or any other hardware platform capable of providing artificial reality content to and receiving inputs from the user 102.

FIG. 1B illustrates an example augmented reality system 100B. The augmented reality system 100B may include a head-mounted display (HMD) 110 (e.g., glasses) comprising a frame 112, one or more displays 114, and a computing system 120. The displays 114 may be transparent or translucent allowing a user wearing the HMD 110 to look through the displays 114 to see the real world and displaying visual artificial reality content to the user at the same time. The HMD 110 may include an audio device that may provide audio artificial reality content to users. The HMD 110 may include one or more cameras which can capture images and videos of environments. The HMD 110 may include an eye tracking system to track the vergence movement of the user wearing the HMD 110. The augmented reality system 100B may further include a controller comprising a trackpad and one or more buttons. The controller may receive inputs from users and relay the inputs to the computing system 120. The controller may also provide haptic feedback to users. The computing system 120 may be connected to the HMD 110 and the controller through cables or wireless connections. The computing system 120 may control the HMD 110 and the controller to provide the augmented reality content to and receive inputs from users. The computing system 120 may be a standalone host computer system, an on-board computer system integrated with the HMD 110, a mobile device, or any other hardware platform capable of providing artificial reality content to and receiving inputs from users.

FIG. 1C illustrates an example architecture 100C of a display engine 130. In particular embodiments, the processes and methods as described in this disclosure may be embodied or implemented within a display engine 130 (e.g., in the display block 135). The display engine 130 may include, for example, but is not limited to, a texture memory 132, a transform block 133, a pixel block 134, a display block 135, input data bus 131, output data bus 142, etc. In particular embodiments, the display engine 130 may include one or more graphic pipelines for generating images to be rendered on the display. For example, the display engine may use the graphic pipeline(s) to generate a series of subframe images based on a mainframe image and a viewpoint or view angle of the user as measured by one or more eye tracking sensors. The mainframe image may be generated or/and loaded in to the system at a mainframe rate of 30-90 Hz and the subframe rate may be generated at a subframe rate of 1-2 kHz. In particular embodiments, the display engine 130 may include two graphic pipelines for the user's left and right eyes. One of the graphic pipelines may include or may be implemented on the texture memory 132, the transform block 133, the pixel block 134, the display block 135, etc. The display engine 130 may include another set of transform block, pixel block, and display block for the other graphic pipeline. The graphic pipeline(s) may be controlled by a controller or control block (not shown) of the display engine 130. In particular embodiments, the texture memory 132 may be included within the control block or may be a memory unit external to the control block but local to the display engine 130. One or more of the components of the display engine 130 may be configured to communicate via a high-speed bus, shared memory, or any other suitable methods. This communication may include transmission of data as well as control signals, interrupts or/and other instructions. For example, the texture memory 132 may be configured to receive image data through the input data bus 211. As another example, the display block 135 may send the pixel values to the display system 140 through the output data bus 142. In particular embodiments, the display system 140 may include three color channels (e.g., 114A, 114B, 114C) with respective display driver ICs (DDIs) of 142A, 142B, and 143B. In particular embodiments, the display system 140 may include, for example, but is not limited to, light-emitting diode (LED) displays, organic light-emitting diode (OLED) displays, active matrix organic light-emitting diode (AMLED) displays, liquid crystal display (LCD), micro light-emitting diode (uLED) display, electroluminescent displays (ELDs), or any suitable displays.

In particular embodiments, the display engine 130 may include a controller block (not shown). The control block may receive data and control packages such as position data and surface information from controllers external to the display engine 130 though one or more data buses. For example, the control block may receive input stream data from a body wearable computing system. The input data stream may include a series of mainframe images generated at a mainframe rate of 30-90 Hz. The input stream data including the mainframe images may be converted to the required format and stored into the texture memory 132. In particular embodiments, the control block may receive input from the body wearable computing system and initialize the graphic pipelines in the display engine to prepare and finalize the image data for rendering on the display. The data and control packets may include information related to, for example, one or more surfaces including texel data, position data, and additional rendering instructions. The control block may distribute data as needed to one or more other blocks of the display engine 130. The control block may initiate the graphic pipelines for processing one or more frames to be displayed. In particular embodiments, the graphic pipelines for the two eye display systems may each include a control block or share the same control block.

In particular embodiments, the transform block 133 may determine initial visibility information for surfaces to be displayed in the artificial reality scene. In general, the transform block 133 may cast rays from pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye tracking sensors, and/or any suitable tracking/localization algorithms, such as simultaneous localization and mapping (SLAM)) into the artificial scene where surfaces are positioned and may produce tile/surface pairs 144 to send to the pixel block 134. In particular embodiments, the transform block 133 may include a four-stage pipeline as follows. A ray caster may issue ray bundles corresponding to arrays of one or more aligned pixels, referred to as tiles (e.g., each tile may include 16×16 aligned pixels). The ray bundles may be warped, before entering the artificial reality scene, according to one or more distortion meshes. The distortion meshes may be configured to correct geometric distortion effects stemming from, at least, the eye display systems the headset system. The transform block 133 may determine whether each ray bundle intersects with surfaces in the scene by comparing a bounding box of each tile to bounding boxes for the surfaces. If a ray bundle does not intersect with an object, it may be discarded. After the tile-surface intersections are detected, the corresponding tile/surface pairs may be passed to the pixel block 134.

In particular embodiments, the pixel block 134 may determine color values or grayscale values for the pixels based on the tile-surface pairs. The color values for each pixel may be sampled from the texel data of surfaces received and stored in texture memory 132. The pixel block 134 may receive tile-surface pairs from the transform block 133 and may schedule bilinear filtering using one or more filer blocks. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation). In particular embodiments, the pixel block 134 may process the red, green, and blue color components separately for each pixel. In particular embodiments, the display may include two pixel blocks for the two eye display systems. The two pixel blocks of the two eye display systems may work independently and in parallel with each other. The pixel block 134 may then output its color determinations (e.g., pixels 138) to the display block 135. In particular embodiments, the pixel block 134 may composite two or more surfaces into one surface to when the two or more surfaces have overlapping areas. A composed surface may need less computational resources (e.g., computational units, memory, power, etc.) for the resampling process.

In particular embodiments, the display block 135 may receive pixel color values from the pixel block 134, covert the format of the data to be more suitable for the scanline output of the display, apply one or more lightness corrections to the pixel color values, and prepare the pixel color values for output to the display. In particular embodiments, the display block 135 may each include a row buffer and may process and store the pixel data received from the pixel block 134. The pixel data may be organized in quads (e.g., 2×2 pixels per quad) and tiles (e.g., 16×16 pixels per tile). The display block 135 may convert tile-order pixel color values generated by the pixel block 134 into scanline or row-order data, which may be required by the physical displays. The lightness corrections may include any required lightness correction, gamma mapping, and dithering. The display block 135 may output the corrected pixel color values directly to the driver of the physical display (e.g., pupil display) or may output the pixel values to a block external to the display engine 130 in a variety of formats. For example, the eye display systems of the headset system may include additional hardware or software to further customize backend color processing, to support a wider interface to the display, or to optimize display speed or fidelity.

In particular embodiments, the dithering methods and processes (e.g., spatial dithering method, temporal dithering methods, and spatio-temporal methods) as described in this disclosure may be embodied or implemented in the display block 135 of the display engine 130. In particular embodiments, the display block 135 may include a model-based dithering algorithm or a dithering model for each color channel and send the dithered results of the respective color channels to the respective display driver ICs (e.g., 142A, 142B, 142C) of display system 140. In particular embodiments, before sending the pixel values to the respective display driver ICs (e.g., 142A, 142B, 142C), the display block 135 may further include one or more algorithms for correcting, for example, pixel non-uniformity, LED non-ideality, waveguide non-uniformity, display defects (e.g., dead pixels), etc.

In particular embodiments, graphics applications (e.g., games, maps, content-providing apps, etc.) may build a scene graph, which is used together with a given view position and point in time to generate primitives to render on a GPU or display engine. The scene graph may define the logical and/or spatial relationship between objects in the scene. In particular embodiments, the display engine 130 may also generate and store a scene graph that is a simplified form of the full application scene graph. The simplified scene graph may be used to specify the logical and/or spatial relationships between surfaces (e.g., the primitives rendered by the display engine 130, such as quadrilaterals or contours, defined in 3D space, that have corresponding textures generated based on the mainframe rendered by the application). Storing a scene graph allows the display engine 130 to render the scene to multiple display frames and to adjust each element in the scene graph for the current viewpoint (e.g., head position), the current object positions (e.g., they could be moving relative to each other) and other factors that change per display frame. In addition, based on the scene graph, the display engine 130 may also adjust for the geometric and color distortion introduced by the display subsystem and then composite the objects together to generate a frame. Storing a scene graph allows the display engine 130 to approximate the result of doing a full render at the desired high frame rate, while actually running the GPU or display engine 130 at a significantly lower rate.

FIG. 1D illustrates an example graphic pipeline 100D of the display engine 130 for generating display image data. In particular embodiments, the graphic pipeline 100D may include a visibility step 152, where the display engine 130 may determine the visibility of one or more surfaces received from the body wearable computing system. The visibility step 152 may be performed by the transform block (e.g., 2133 in FIG. 1C) of the display engine 130. The display engine 130 may receive (e.g., by a control block or a controller) input data 151 from the body-wearable computing system. The input data 151 may include one or more surfaces, texel data, position data, RGB data, and rendering instructions from the body wearable computing system. The input data 151 may include mainframe images with 30-90 frames per second (FPS). The main frame image may have color depth of, for example, 24 bits per pixel. The display engine 130 may process and save the received input data 151 in the texel memory 132. The received data may be passed to the transform block 133 which may determine the visibility information for surfaces to be displayed. The transform block 133 may cast rays for pixel locations on the screen and produce filter commands (e.g., filtering based on bilinear or other types of interpolation techniques) to send to the pixel block 134. The transform block 133 may perform ray casting from the current viewpoint of the user (e.g., determined using the headset's inertial measurement units, eye trackers, and/or any suitable tracking/localization algorithms, such as simultaneous localization and mapping (SLAM)) into the artificial scene where surfaces are positioned and produce surface-tile pairs to send to the pixel block 134.

In particular embodiments, the graphic pipeline 100D may include a resampling step 153, where the display engine 130 may determine the color values from the tile-surfaces pairs to produce pixel color values. The resampling step 153 may be performed by the pixel block 134 in FIG. 1C) of the display engine 130. The pixel block 134 may receive tile-surface pairs from the transform block 133 and may schedule bilinear filtering. For each tile-surface pair, the pixel block 134 may sample color information for the pixels within the tile using color values corresponding to where the projected tile intersects the surface. The pixel block 134 may determine pixel values based on the retrieved texels (e.g., using bilinear interpolation) and output the determined pixel values to the respective display block 135.

In particular embodiments, the graphic pipeline 100D may include a bend step 154, a correction and dithering step 155, a serialization step 156, etc. In particular embodiments, the bend step, correction and dithering step, and serialization steps of 154, 155, and 156 may be performed by the display block (e.g., 135 in FIG. 1C) of the display engine 130. The display engine 130 may blend the display content for display content rendering, apply one or more lightness corrections to the pixel color values, perform one or more dithering algorithms for dithering the quantization errors both spatially and temporally, serialize the pixel values for scanline output for the physical display, and generate the display data 159 suitable for the display system 140. The display engine 130 may send the display data 159 to the display system 140. In particular embodiments, the display system 140 may include three display driver ICs (e.g., 142A, 142B, 142C) for the pixels of the three color channels of RGB (e.g., 144A, 144B, 144C).

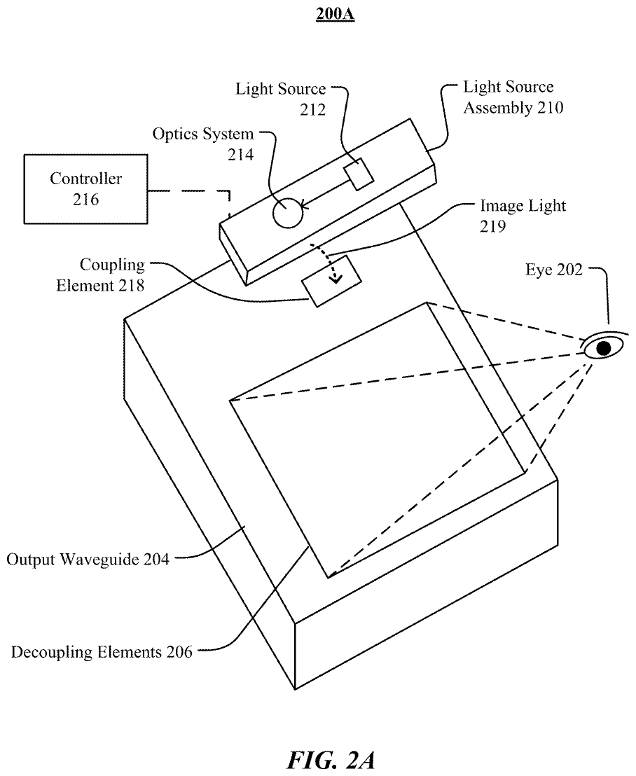

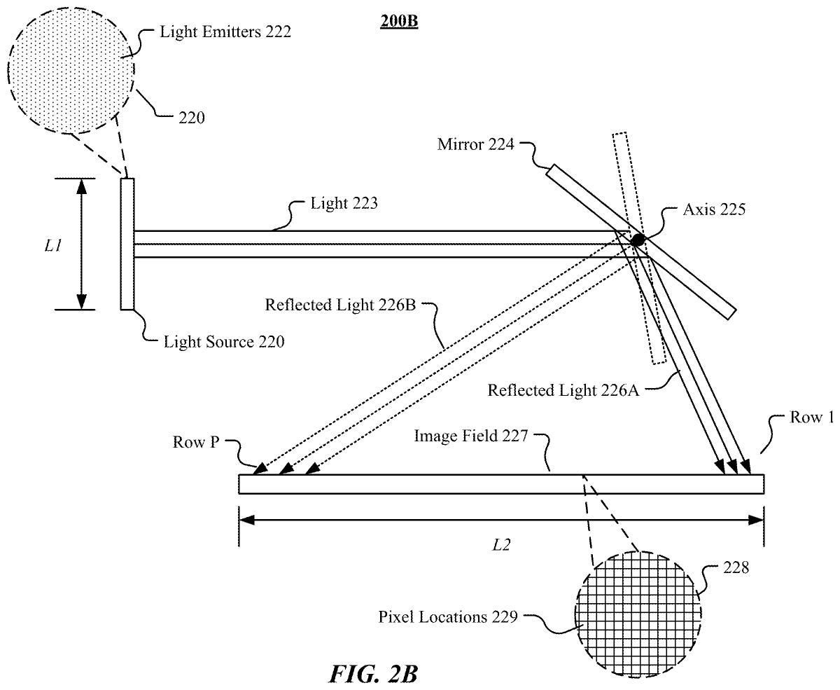

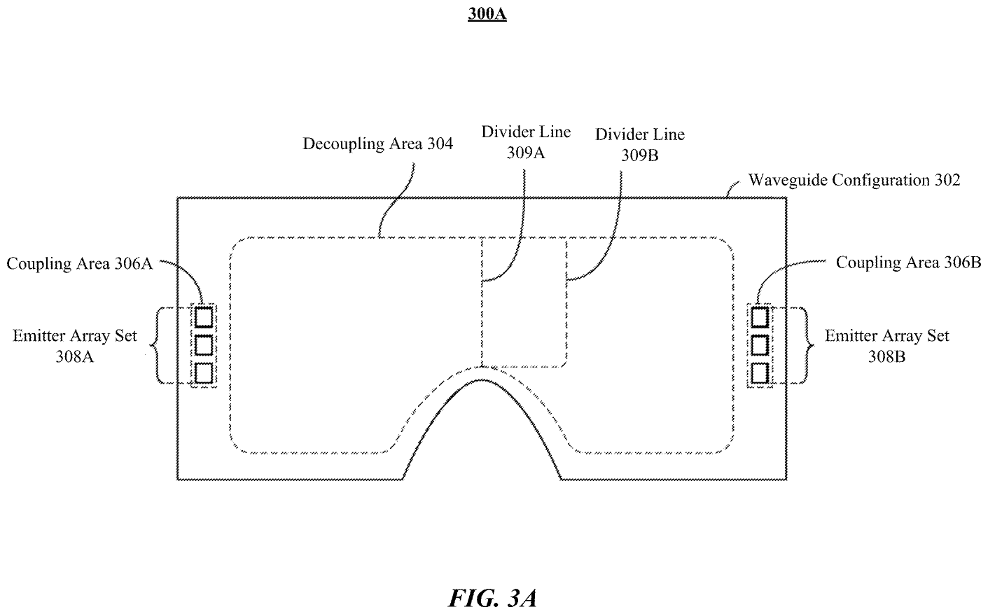

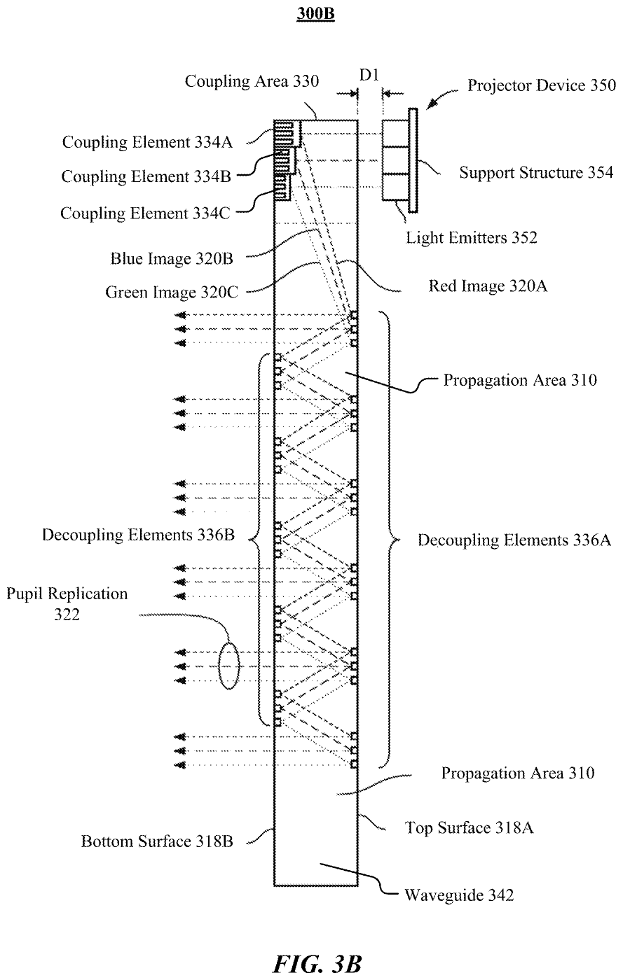

FIG. 2A illustrates an example scanning waveguide display 200A. In particular embodiments, the head-mounted display (HMD) of the AR/VR system may include a near eye display (NED) which may be a scanning waveguide display 200A. The scanning waveguide display 200A may include a light source assembly 210, an output waveguide 204, a controller 216, etc. The scanning waveguide display 200A may provide images for both eyes or for a single eye. For purposes of illustration, FIG. 3A shows the scanning waveguide display 200A associated with a single eye 202. Another scanning waveguide display (not shown) may provide image light to the other eye of the user and the two scanning waveguide displays may share one or more components or may be separated. The light source assembly 210 may include a light source 212 and an optics system 214. The light source 212 may include an optical component that could generate image light using an array of light emitters. The light source 212 may generate image light including, for example, but not limited to, red image light, blue image light, green image light, infra-red image light, etc. The optics system 214 may perform a number of optical processes or operations on the image light generated by the light source 212. The optical processes or operations performed by the optics systems 214 may include, for example, but are not limited to, light focusing, light combining, light conditioning, scanning, etc.

In particular embodiments, the optics system 214 may include a light combining assembly, a light conditioning assembly, a scanning mirror assembly, etc. The light source assembly 210 may generate and output an image light 219 to a coupling element 218 of the output waveguide 204. The output waveguide 204 may be an optical waveguide that could output image light to the user eye 202. The output waveguide 204 may receive the image light 219 at one or more coupling elements 218 and guide the received image light to one or more decoupling elements 206. The coupling element 218 may be, for example, but is not limited to, a diffraction grating, a holographic grating, any other suitable elements that can couple the image light 219 into the output waveguide 204, or a combination thereof. As an example and not by way of limitation, if the coupling element 350 is a diffraction grating, the pitch of the diffraction grating may be chosen to allow the total internal reflection to occur and the image light 219 to propagate internally toward the decoupling element 206. The pitch of the diffraction grating may be in the range of 300 nm to 600 nm. The decoupling element 206 may decouple the total internally reflected image light from the output waveguide 204. The decoupling element 206 may be, for example, but is not limited to, a diffraction grating, a holographic grating, any other suitable element that can decouple image light out of the output waveguide 204, or a combination thereof. As an example and not by way of limitation, if the decoupling element 206 is a diffraction grating, the pitch of the diffraction grating may be chosen to cause incident image light to exit the output waveguide 204. The orientation and position of the image light exiting from the output waveguide 204 may be controlled by changing the orientation and position of the image light 219 entering the coupling element 218. The pitch of the diffraction grating may be in the range of 300 nm to 600 nm.

In particular embodiments, the output waveguide 204 may be composed of one or more materials that can facilitate total internal reflection of the image light 219. The output waveguide 204 may be composed of one or more materials including, for example, but not limited to, silicon, plastic, glass, polymers, or some combination thereof. The output waveguide 204 may have a relatively small form factor. As an example and not by way of limitation, the output waveguide 204 may be approximately 50 mm wide along X-dimension, 30 mm long along Y-dimension and 0.5-1 mm thick along Z-dimension. The controller 216 may control the scanning operations of the light source assembly 210. The controller 216 may determine scanning instructions for the light source assembly 210 based at least on the one or more display instructions for rendering one or more images. The display instructions may include an image file (e.g., bitmap) and may be received from, for example, a console or computer of the AR/VR system. Scanning instructions may be used by the light source assembly 210 to generate image light 219. The scanning instructions may include, for example, but are not limited to, an image light source type (e.g., monochromatic source, polychromatic source), a scanning rate, a scanning apparatus orientation, one or more illumination parameters, or some combination thereof. The controller 216 may include a combination of hardware, software, firmware, or any suitable components supporting the functionality of the controller 216.

FIG. 2B illustrates an example scanning operation of a scanning waveguide display 200B. The light source 220 may include an array of light emitters 222 (as represented by the dots in inset) with multiple rows and columns. The light 223 emitted by the light source 220 may include a set of collimated beams of light emitted by each column of light emitters 222. Before reaching the mirror 224, the light 223 may be conditioned by different optical devices such as the conditioning assembly (not shown). The mirror 224 may reflect and project the light 223 from the light source 220 to the image field 227 by rotating about an axis 225 during scanning operations. The mirror 224 may be a microelectromechanical system (MEMS) mirror or any other suitable mirror. As the mirror 224 rotates about the axis 225, the light 223 may be projected to a different part of the image field 227, as illustrated by the reflected part of the light 226A in solid lines and the reflected part of the light 226B in dash lines.

In particular embodiments, the image field 227 may receive the light 226A-B as the mirror 224 rotates about the axis 225 to project the light 226A-B in different directions. For example, the image field 227 may correspond to a portion of the coupling element 218 or a portion of the decoupling element 206 in FIG. 2A. In particular embodiments, the image field 227 may include a surface of the coupling element 206. The image formed on the image field 227 may be magnified as light travels through the output waveguide 220. In particular embodiments, the image field 227 may not include an actual physical structure but include an area to which the image light is projected to form the images. The image field 227 may also be referred to as a scan field. When the light 223 is projected to an area of the image field 227, the area of the image field 227 may be illuminated by the light 223. The image field 227 may include a matrix of pixel locations 229 (represented by the blocks in inset 228) with multiple rows and columns. The pixel location 229 may be spatially defined in the area of the image field 227 with a pixel location corresponding to a single pixel. In particular embodiments, the pixel locations 229 (or the pixels) in the image field 227 may not include individual physical pixel elements. Instead, the pixel locations 229 may be spatial areas that are defined within the image field 227 and divide the image field 227 into pixels. The sizes and locations of the pixel locations 229 may depend on the projection of the light 223 from the light source 220. For example, at a given rotation angle of the mirror 224, light beams emitted from the light source 220 may fall on an area of the image field 227. As such, the sizes and locations of pixel locations 229 of the image field 227 may be defined based on the location of each projected light beam. In particular embodiments, a pixel location 229 may be subdivided spatially into subpixels (not shown). For example, a pixel location 229 may include a red subpixel, a green subpixel, and a blue subpixel. The red, green and blue subpixels may correspond to respective locations at which one or more red, green and blue light beams are projected. In this case, the color of a pixel may be based on the temporal and/or spatial average of the pixel's subpixels.

In particular embodiments, the light emitters 222 may illuminate a portion of the image field 227 (e.g., a particular subset of multiple pixel locations 229 on the image field 227) with a particular rotation angle of the mirror 224. In particular embodiment, the light emitters 222 may be arranged and spaced such that a light beam from each of the light emitters 222 is projected on a corresponding pixel location 229. In particular embodiments, the light emitters 222 may include a number of light-emitting elements (e.g., micro-LEDs) to allow the light beams from a subset of the light emitters 222 to be projected to a same pixel location 229. In other words, a subset of multiple light emitters 222 may collectively illuminate a single pixel location 229 at a time. As an example and not by way of limitation, a group of light emitter including eight light-emitting elements may be arranged in a line to illuminate a single pixel location 229 with the mirror 224 at a given orientation angle.

In particular embodiments, the number of rows and columns of light emitters 222 of the light source 220 may or may not be the same as the number of rows and columns of the pixel locations 229 in the image field 227. In particular embodiments, the number of light emitters 222 in a row may be equal to the number of pixel locations 229 in a row of the image field 227 while the light emitters 222 may have fewer columns than the number of pixel locations 229 of the image field 227. In particular embodiments, the light source 220 may have the same number of columns of light emitters 222 as the number of columns of pixel locations 229 in the image field 227 but fewer rows. As an example and not by way of limitation, the light source 220 may have about 1280 columns of light emitters 222 which may be the same as the number of columns of pixel locations 229 of the image field 227, but only a handful rows of light emitters 222. The light source 220 may have a first length L1 measured from the first row to the last row of light emitters 222. The image field 530 may have a second length L2, measured from the first row (e.g., Row 1) to the last row (e.g., Row P) of the image field 227. The L2 may be greater than L1 (e.g., L2 is 50 to 10,000 times greater than L1).

In particular embodiments, the number of rows of pixel locations 229 may be larger than the number of rows of light emitters 222. The display device 200B may use the mirror 224 to project the light 223 to different rows of pixels at different time. As the mirror 520 rotates and the light 223 scans through the image field 227, an image may be formed on the image field 227. In some embodiments, the light source 220 may also has a smaller number of columns than the image field 227. The mirror 224 may rotate in two dimensions to fill the image field 227 with light, for example, using a raster-type scanning process to scan down the rows then moving to new columns in the image field 227. A complete cycle of rotation of the mirror 224 may be referred to as a scanning period which may be a predetermined cycle time during which the entire image field 227 is completely scanned. The scanning of the image field 227 may be determined and controlled by the mirror 224 with the light generation of the display device 200B being synchronized with the rotation of the mirror 224. As an example and not by way of limitation, the mirror 224 may start at an initial position projecting light to Row 1 of the image field 227, and rotate to the last position that projects light to Row P of the image field 227, and then rotate back to the initial position during one scanning period. An image (e.g., a frame) may be formed on the image field 227 per scanning period. The frame rate of the display device 200B may correspond to the number of scanning periods in a second. As the mirror 224 rotates, the light may scan through the image field to form images. The actual color value and light intensity or lightness of a given pixel location 229 may be a temporal sum of the color various light beams illuminating the pixel location during the scanning period. After completing a scanning period, the mirror 224 may revert back to the initial position to project light to the first few rows of the image field 227 with a new set of driving signals being fed to the light emitters 222. The same process may be repeated as the mirror 224 rotates in cycles to allow different frames of images to be formed in the scanning field 227.

FIG. 3A illustrates an example 2D micro-LED waveguide display 300A. In particular embodiments, the display 300A may include an elongate waveguide configuration 302 that may be wide or long enough to project images to both eyes of a user. The waveguide configuration 302 may include a decoupling area 304 covering both eyes of the user. In order to provide images to both eyes of the user through the waveguide configuration 302, multiple coupling areas 306A-B may be provided in a top surface of the waveguide configuration 302. The coupling areas 306A and 306B may include multiple coupling elements to receive image light from light emitter array sets 308A and 308B, respectively. Each of the emitter array sets 308A-B may include a number of monochromatic emitter arrays including, for example, but not limited to, a red emitter array, a green emitter array, and a blue emitter array. In particular embodiments, the emitter array sets 308A-B may further include a white emitter array or an emitter array emitting other colors or any combination of any multiple colors. In particular embodiments, the waveguide configuration 302 may have the emitter array sets 308A and 308B covering approximately identical portions of the decoupling area 304 as divided by the divider line 309A. In particular embodiments, the emitter array sets 308A and 308B may provide images to the waveguide of the waveguide configuration 302 asymmetrically as divided by the divider line 309B. For example, the emitter array set 308A may provide image to more than half of the decoupling area 304. In particular embodiments, the emitter array sets 308A and 308B may be arranged at opposite sides (e.g., 180° apart) of the waveguide configuration 302 as shown in FIG. 3B. In other embodiments, the emitter array sets 308A and 308B may be arranged at any suitable angles. The waveguide configuration 302 may be planar or may have a curved cross-sectional shape to better fit to the face/head of a user.

FIG. 3B illustrates an example waveguide configuration 300B for the 2D micro-LED waveguide display. In particular embodiments, the waveguide configuration 300B may include a projector device 350 coupled to a waveguide 342. The projector device 320 may include a number of light emitters 352 (e.g., monochromatic emitters) secured to a support structure 354 (e.g., a printed circuit board or other suitable support structure). The waveguide 342 may be separated from the projector device 350 by an air gap having a distance of D1 (e.g., approximately 50 μm to approximately 500 μm). The monochromatic images projected by the projector device 350 may pass through the air gap toward the waveguide 342. The waveguide 342 may be formed from a glass or plastic material. The waveguide 342 may include a coupling area 330 including a number of coupling elements 334A-C for receiving the emitted light from the projector device 350. The waveguide 342 may include a decoupling area with a number of decoupling elements 336A on the top surface 318A and a number of decoupling elements 336B on the bottom surface 318B. The area within the waveguide 342 in between the decoupling elements 336A and 336B may be referred as a propagation area 310, in which image light received from the projector device 350 and coupled into the waveguide 342 by the coupling element 334 may propagate laterally within the waveguide 342.

The coupling area 330 may include coupling elements (e.g., 334A, 334B, 334C) configured and dimensioned to couple light of predetermined wavelengths (e.g., red, green, blue). When a white light emitter array is included in the projector device 350, the portion of the white light that falls in the predetermined wavelengths may be coupled by each of the coupling elements 334A-C. In particular embodiments, the coupling elements 334A-B may be gratings (e.g., Bragg gratings) dimensioned to couple a predetermined wavelength of light. In particular embodiments, the gratings of each coupling element may exhibit a separation distance between gratings associated with the predetermined wavelength of light and each coupling element may have different grating separation distances. Accordingly, each coupling element (e.g., 334A-C) may couple a limited portion of the white light from the white light emitter array of the projector device 350 if white light emitter array is included in the projector device 350. In particular embodiments, each coupling element (e.g., 334A-C) may have the same grating separation distance. In particular embodiments, the coupling elements 334A-C may be or include a multiplexed coupler.

As illustrated in FIG. 3B, a red image 320A, a blue image 320B, and a green image 320C may be coupled by the coupling elements 334A, 334B, 334C, respectively, into the propagation area 310 and may begin to traverse laterally within the waveguide 342. A portion of the light may be projected out of the waveguide 342 after the light contacts the decoupling element 336A for one-dimensional pupil replication, and after the light contacts both the decoupling elements 336A and 336B for two-dimensional pupil replication. In two-dimensional pupil replication, the light may be projected out of the waveguide 342 at locations where the pattern of the decoupling element 336A intersects the pattern of the decoupling element 336B. The portion of the light that is not projected out of the waveguide 342 by the decoupling element 336A may be reflected off the decoupling element 336B. The decoupling element 336B may reflect all incident light back toward the decoupling element 336A. Accordingly, the waveguide 342 may combine the red image 320A, the blue image 320B, and the green image 320C into a polychromatic image instance which may be referred as a pupil replication 322. The polychromatic pupil replication 322 may be projected to the user's eyes which may interpret the pupil replication 322 as a full color image (e.g., an image including colors addition to red, green, and blue). The waveguide 342 may produce tens or hundreds of pupil replication 322 or may produce a single replication 322.

In particular embodiments, the AR/VR system may use scanning waveguide displays or 2D micro-LED displays for displaying AR/VR content to users. In order to miniaturize the AR/VR system, the display system may need to miniaturize the space for pixel circuits and may have limited number of available bits for the display. The number of available bits in a display may limit the display's color depth or gray scale level, and consequently limit the quality of the displayed images. Furthermore, the waveguide displays used for AR/VR systems may have nonuniformity problem cross all display pixels. The compensation operations for pixel nonuniformity may result in loss on image grayscale and further reduce the quality of the displayed images. For example, a waveguide display with 8-bit pixels (i.e., 256 gray level) may equivalently have 6-bit pixels (i.e., 64 gray level) after compensation of the nonuniformity (e.g., 8:1 waveguide nonuniformity, 0.1% dead micro-LED pixel, and 20% micro-LED intensity nonuniformity).

To improve the displayed image quality, displays with limited color depth or gray scale level may use spatio dithering to spread quantization errors to neighboring pixels and generate the illusion of increased color depth or gray scale level. To further increase the color depth or gray scale level, displays may generate a series of temporal subframe images with less gray level bits to give the illusion of a target image which has more gray level bits. Each subframe image may be dithered using spatio dithering techniques within that subframe image. The temporal average or aggregation of the series of subframe image may correspond to the image as perceived by the viewer. For example, for display an image with 8-bit pixels (i.e., 256 gray levels), the system may use four subframe images each having 6-bit pixels (i.e., 64 gray level) to represent the 8-bit target image. As another example, an image with 8-bit pixels (i.e., 256 gray levels) may be represented by 16 subframe images each having 4-bit pixels (i.e., 16 gray levels). This would allow the display system to render images of more gray level (e.g., 8-bit pixels) with pixel circuits and supporting hardware for less gray levels (e.g., 6-bit pixels or 4-bit pixels), and therefore reduce the space and size of the display system.

AR/VR display may use waveguides to transmit light of RGB colors for displaying images. However, the waveguides may be non-uniform in transmitting light of different colors. For example, some waveguides may have a slowly varying transmission character in each of its color channels. For displaying a flat white image, the waveguides may have slowly varying color distortion cross of the FOV. These color distortions may move over the places, because as the viewer looks through the waveguide at different angles, the distortion pattern may change. To correct the waveguide non-uniformity, AR/VR systems usually use pre-computed waveguide correction maps (or correction masks) to adjust the pixel values of the images to calibrate the waveguide non-uniformity. The system may measure the transmission of the waveguides of each color channel, find the inverse, and apply that to the image pixel values to calibrate out the non-uniformity effect. However, the uLEDs may have limited brightness. Due to the limitation of uLEDs, such corrections are limited to a maximum to minimum ratio in each color channel. For example, uLEDs may have a limitation for the available brightness that the uLEDs can produce. Because that limitation, the system may only perform the correction such that the maximum to minimum ratio is limited to 5:1. If the waveguide has a variation beyond 5:1 (e.g., 10:1), the system may only correct the first 5:1 of the distortion due to the brightness limitation of the uLEDs. As a result, the displayed images will have some regions that cannot be perfectly corrected in this way, resulting in visual artifacts related to chrominance or luminance. To address these problems, the system may use an optimizer to determine optimized correction factors by trading off the luminance and chrominance errors. It is notable that the systems, methods, processes, and principles as described in this disclosure is not limited to solve the problems as explained by the above examples. The systems, methods, processes, and principles as described in this disclosure may be applicable to a much wide range of problems (e.g., with other suitable maximum to minimum rate numbers).

To solve these problems, particular embodiments in this disclosure may use an optimization process, which trades off the luminance and chrominance errors, to calculate optimized correction factors which can be used to adjust image pixel values to correct waveguide non-uniformity. The optimization process may be subject to an upper and lower bound corresponding to the clipping factor which corresponds to a maximum to minimum ratio as limited by the uLEDs performance limitation. The system may incorporate the clipping factor by subjecting the optimization process to a pre-determined range for the correction factor values as determined by the clipping factor. The correction factors may be included in a correction map or mask, which can be stored in a computer storage and retrieved at runtime to adjust pixel values of images to correct the waveguide non-uniformity before the images are displayed. To generate the pre-computed correction map or mask, the system may first measure the waveguide transmission characters in the tristimulus color space (X, Y, Z). Then, the system may convert the waveguide tristimulus transmission into an opponent color space (L, O₁, O₂). After that, the system may use the optimizer to compute the correction factor values that minimize the chrominance or/and luminance errors, as weighted by the weighting parameter.

In one embodiment, the system may perform the optimization process by taking into consideration all three dimensions of (L, O₁, O₂) in the opponent color space. As a result, the optimization process may minimize both the luminance and chrominance errors at the same time. In another embodiment, the system may perform the optimization process by only considering two dimensions (O₁, O₂) of the opponent color space to minimize only the chrominance error, leaving the luminance error uncorrected. The resulting images may have improved chrominance correction results but may have visual artifacts in the luminance dimension. In yet another embodiment, the optimization process may trade off the luminance error and the chrominance error using a weighting parameter in the optimization process. The weighting parameter may weight the luminance component (L) against the two chrominance components (O₁ and O₂) based on its value. A greater value for the weighting parameter may allow the system to reduce the luminance errors by a higher degree (and, accordingly, reduce the chrominance errors by a lower degree), and thus to have more accurate colors but less accurate luminance. For example, a weighting parameter of 1 may allow the luminance error and chrominance error to be weighted equally and allow the system to minimize the luminance error to the same extent as to the chrominance error. On the other hand, a smaller value for the weighting parameter may reduce the chrominance errors to a higher degree and accordingly reduce the luminance error to a lower degree. For example, the weighting parameter value of 0 may allow the system to only minimize the chrominance errors, leaving the luminance error uncorrected. The system may use a second optimization process to determine an optimized weighting parameter value for trading off the luminance and the chrominance errors. In some embodiments, each color channel of the RGB color channels may use the same weighting parameter value. In some other embodiments, each color channel may use a different weighting parameter value. The system may determine the optimized weighting value(s) based on the display quality of the corrected images (e.g., the chrominance errors and luminance errors as perceived by viewers). Using the optimization process, the system may determine the optimized correction factor value for each pixel of the image to be displayed. The system may repeat this process to determine a correction map or correction mask, which includes all the correction factors for all pixels of the display. Then, the system may store the pre-computed correction map or mask in a computer storage. At runtime, the system may retrieve the correction map or mask from the computer storage and apply it to the images to be displayed to adjust the pixel values of the images. The images with the adjusted pixel values based on the correction factors, once displayed, may have less chrominance or/and luminance errors as perceived by the viewer. In some embodiments, the correction factors may be customized based on the viewer's eye position with respect to a number of pre-determined positions associated with an eye box of the viewer.

By using an optimization process subject to a predetermined constraint corresponding to the clipping factor, the system may generate a pre-computed correction map or correction mask that can be used to adjust the pixel values of the image to be displayed, to correct the waveguide non-uniformity. With the waveguide non-uniformity being corrected, the display images may have better visual results (e.g., more accurate colors or/and luminance) as perceived by the viewer. In some embodiments, the system may achieve better image quality for the displayed images by using the correction map that minimizes the chrominance error but leaves the luminance error largely untouched in some image regions, taking advantage of the fact that the human vision system is more sensitive to the chrominance errors than the luminance errors. In some embodiments, the system may achieve an overall optimized display results by trading off the luminance errors and the chrominance errors. In some embodiments, the system may achieve optimized display results by considering a number of positions with an eye box.

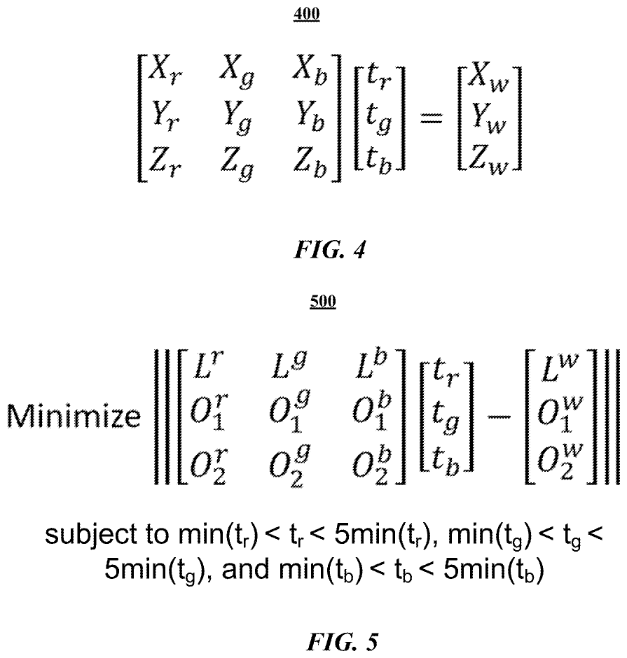

FIG. 4 illustrates an example calculation process 400 for determining waveguide correction factors in the tristimulus color space. In particular embodiments, the waveguide correction factors for each color channel (tᵣ, t_{g}, t_{b}) may be found by computing the relative intensities required to match the waveguide tristimulus transmission (X_{rgb}, Y_{rgb}, Z_{rgb}) to D65 white using the following equation:

$$[ \begin{matrix}{X}_{r} & {X}_{g} & {X}_{b} \\ {Y}_{r} & {Y}_{g} & {Y}_{b} \\ {Z}_{r} & {Z}_{g} & {Z}_{b}\end{matrix} ] [ \begin{matrix}{t}_{r} \\ {t}_{g} \\ {t}_{b}\end{matrix} ] = [ \begin{matrix}{X}_{w} \\ {Y}_{w} \\ {Z}_{w}\end{matrix} ] \qquad ( 1 )$$

where (X_{rgb}, Y_{rgb}, Z_{rgb}) are the waveguide tristimulus transmission as measured during a pre-measurement process; (tᵣ, t_{g}, t_{b}) are the correction factors for RGB color channels of a particular pixel of the display; (X_{w}, Y_{w}, Z_{w}) are the D65 white. The system may determine the correction factors (tᵣ, t_{g}, t_{b}) for each pixel of the display and generate a correction map or mask based on the correction factors for the whole image. The correction map or mask may be a three-dimensional array storing the correction factors (tᵣ, t_{g}, t_{b}) for each pixel of the display. Then, the waveguide correction factors (tᵣ, t_{g}, t_{b}) may be clipped so that the maximum correction factor value in each channel is N times the minimum value (e.g., N=5). Such N-time limitation may correspond to the brightness limitation as imposed by the uLED performance. As a result, some regions of the image may be effectively corrected. However, some other regions of the image may be uncorrectable in this way due to the limitation of the clipping factor. For example, for an image as corrected using this process, the image may have color distortions in one or more image regions (e.g., a corner image region, an edge image region, etc.). In such image regions, the displayed image colors may deviate from the target colors and the luminance may deviate from the target luminance value, resulting in visual artifacts in these image regions.

In particular embodiments, the system may use an optimization process subject to a clipping factor to determine the optimized correction factor values. Instead of clipping the corrected results at end, in particular embodiments, the system may incorporate a clipping factor (e.g., corresponding to a maximum to minimum ratio of 5:1 for the correction factor values in each color channel) by subjecting the optimization process to the pre-determined ranges of: min(tᵣ)<tᵣ<min(tᵣ), min(t_{g})<t_{g}<min(t_{g}), and min(t_{b})<t_{b}<min(t_{b}). In other words, the respective maximum to minimum ratios of the correction factor values may be limited to no more than 5:1. Such a clipping factor may correspond to a maximum to minimum ratio of each color channel as limited by the uLEDs performance. As such, the optimization process may be subject to an upper and lower bound corresponding to the clipping factor as limited by the maximum to minimum ratio as imposed by the uLEDs. By incorporating such clipping factor, the system may find the optimized correction factors (tᵣ, t_{g}, t_{b}) under the constraints imposed by the limitation of the uLEDs. By using the optimizer in the opponent color space, the optimized correction factors may effectively reduce the visual artifacts related to the chrominance and luminance errors in the opponent color space as perceived by the viewer. It is notable that the 5:1 ratio is for example purpose only and the ratio can be any suitable number as determined by the uLEDs of the display system. The correction factors may be included in a correction map or mask, which can be stored in a computer storage and retrieved at run time to adjust pixel values of images to correct the waveguide non-uniformity before the images are displayed. The correction map or mask may be a three-dimensional array storing the correction factors of (tᵣ, t_{g}, t_{b}) for each pixel of the target image. In particular embodiments, instead of using the tristimulus space to calculate the correction factors, the system may use the opponent color space, which more accurately represents what is perceived by viewers, to calculate the correction factor values. The system may perform the optimization process by taking into consideration all three components of L, O₁, and O₂ in the opponent color space. As a result, the optimization process may minimize both the luminance and chrominance errors at the same time.

FIG. 5 illustrates an example optimization process 500 of determining the correction factors for correcting both luminance and chrominance errors. To generate the pre-computed correction map or mask, the system may first measure the waveguide transmission characters (X_{rgb}, Y_{rgb}, Z_{rgb}) in the tristimulus space. Then, the system may convert the waveguide tristimulus transmission into an opponent color space (L^{rgb}, O₁^{rgb} O₂^{rgb}). After that, the system may use the optimizer to compute the correction factor values that can minimize both chrominance and luminance errors as shown in the following equation:

$$Minimize ‖ [ \begin{matrix}{L}^{r} & {L}^{g} & {L}^{b} \\ {O}_{1}^{r} & {O}_{1}^{g} & {O}_{1}^{b} \\ {O}_{2}^{r} & {O}_{2}^{g} & {O}_{2}^{b}\end{matrix} ] [ \begin{matrix}{t}_{r} \\ {t}_{g} \\ {t}_{b}\end{matrix} ] - [ \begin{matrix}{L}^{w} \\ {O}_{1}^{w} \\ {O}_{2}^{w}\end{matrix} ] ‖ \qquad ( 2 )$$

where (L^{r}, O₁^{r} O₂^{r}) are the opponent color space components for the Red color channel; (L^{g}, O₁^{g} O₂^{g}) are the opponent color space components for the Green color channel; (L^{b}, O₁^{b}, O₂^{b}) are the opponent color space components for the Blue color channel; (tᵣ, t_{g}, t_{b}) are the correction factors for RGB color channels of a particular pixel of the display; (L^{w}, O₁^{w} O₂^{w}) represents the D65 white in the opponent color space.

In the optimization process, the system may use the optimizer as shown in Equation (2) to calculate the correction factor values (tᵣ, t_{g}, t_{b}) that can minimize the difference between the corrected waveguide tristimulus transmission and the D65 white in the opponent color space. The system may first calculate the corrected waveguide tristimulus transmission in the opponent color space by applying tentative values of correction factors to the waveguide tristimulus transmission in the opponent color space. Then, the system may calculate the difference between the corrected waveguide tristimulus transmission and the target D65 white in the opponent color space. After that, the system may adjust the correction factor values and repeat the above process to compare the resulting difference values. The system may iterate through such optimization process to search for the optimized correction factors (tᵣ, t_{g}, t_{b}) that can minimize the difference between the corrected waveguide tristimulus transmission and the target D65 white in the opponent color space. In particular embodiments, the system may measure the waveguide transmission characters in the tristimulus space with the native resolution of the display (with the waveguide). Then, the system may convert the waveguide tristimulus transmission into an opponent color space and compute the correction factor values that can minimize the chrominance/luminance errors. This may be done for every pixel of the display to generate the correction map. In particular embodiments, the correction map may need to have a same resolution with the images to be displayed, which may be a lower or higher resolution to the native resolution of the display. The system may down sample or up sample the correction map to have an appropriate resolution that matches the images to be displayed.

It is notable that the optimization process in Equation (2) considers both the luminance errors (corresponding to the L component of the opponent color space) and the chrominance errors (corresponding to the O₁ and O₂ components of the opponent color space). Thus, in some situations, when the luminance errors and the chrominance errors cannot be both corrected, the results images may still have some artifacts. However, by performing the optimization in the opponent color space, such optimizer may provide the flexibility that enables the system to trade off the corrections of the luminance and chrominance errors, as discussed later.

In particular embodiments, the system may perform the optimization process by only considering two components O₁ and O₂ of the opponent color space to correct only the chrominance errors, leaving the luminance error uncorrected. The resulting images may have improved chrominance correction results but may have visual artifacts in the luminance dimension. The system may use an optimizer during an optimization process to determine the correction factor values for correcting the chrominance errors. The system may incorporate a clipping factor (e.g., a maximum to minimum ratio of 5:1 for the correction factors values in each color channel) by subjecting the optimization process to the pre-determined ranges of: min(tᵣ)<tᵣ<5 min(tᵣ), min(t_{g})<t_{g}<5 min(t_{g}), and min(t_{b})<t_{b}<5 min(t_{b}). In other words, the respective maximum to minimum ratios of the values of the correction factors tᵣ, t_{g}, t_{b} may be limited to no more than 5:1. Such a clipping factor may correspond to a maximum to minimum ratio of each color channel as limited by the uLEDs performance. As such, the optimization process may be subject to an upper and lower bound corresponding to the clipping factor as limited by the maximum to minimum ratio as imposed by the uLEDs. By incorporating such clipping factor, the system may find the optimized correction factors (tᵣ, t_{g}, t_{b}) under the constraints imposed by the limitation of the uLEDs. By using the optimizer in the opponent color space, the optimized correction factors may effectively reduce the visual artifacts related to the chrominance and luminance errors in the opponent color space as perceived by the viewer. The correction factors may be included in a correction map or mask, which can be stored in a computer storage and retrieved at run time to adjust pixel values of images to correct the waveguide non-uniformity before the images are displayed. The correction map or mask may be a three-dimensional array storing the correction factors of (tᵣ t_{g} t_{b}) for each pixel of the target image.

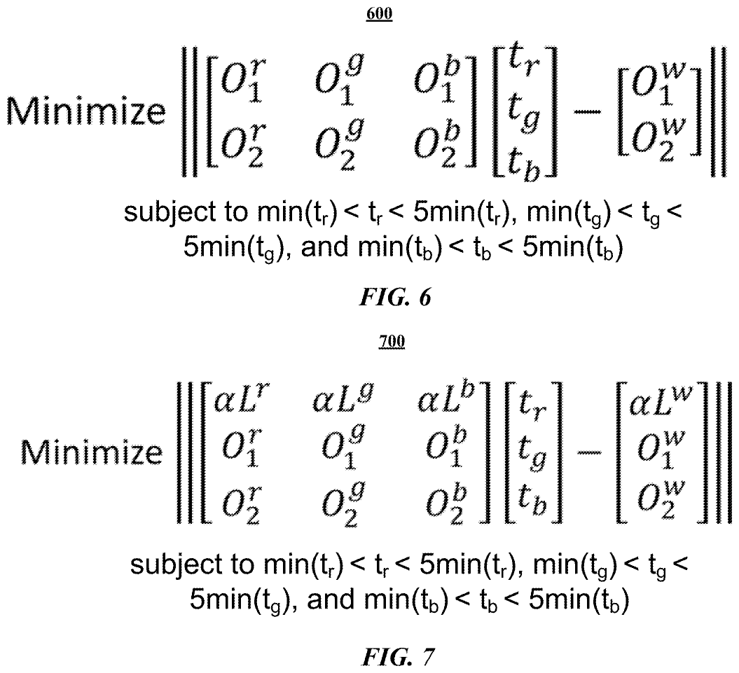

FIG. 6 illustrates an example optimization process 600 of determining the correction factors for correcting chrominance errors. To generate the pre-computed correction map or mask, the system may first measure the waveguide transmission characters (X_{rgb}, Y_{rgb}, Z_{rgb}) in the tristimulus space. Then, the system may convert the waveguide tristimulus transmission into an opponent color space (L^{rgb}, O₁^{rgb} O₂^{rgb}). After that, the system may use the optimizer to compute the correction factor values that can minimize the chrominance errors as shown in the following equation:

$$Minimize ‖ [ \begin{matrix}{O}_{1}^{r} & {O}_{1}^{g} & {O}_{1}^{b} \\ {O}_{2}^{r} & {O}_{2}^{g} & {O}_{2}^{b}\end{matrix} ] [ \begin{matrix}{t}_{r} \\ {t}_{g} \\ {t}_{b}\end{matrix} ] - [ \begin{matrix}{O}_{1}^{w} \\ {O}_{2}^{w}\end{matrix} ] ‖ \qquad ( 3 )$$

where (O₁^{r}, O₂^{r}) are the chrominance components of the opponent color space for the Red color channel; (O₁^{g}, O₂^{g}) are the chrominance components of the opponent color space for the Green color channel; (O₁^{b}, O₂^{b}) are the chrominance components of the opponent color space for the Blue color channel; (tᵣ t_{g} t_{b}) are the correction factors for RGB color channels of a particular pixel of the display; (O₁^{w}, O₂^{w}) are the chrominance components of the D65 white in the opponent color space.

In particular embodiments, during the optimization process, the system may use the optimizer as shown in Equation (3) to calculate and optimize the correction factor values (tᵣ, t_{g}, t_{b}). The optimized correction factor values (tᵣ, t_{g}, t_{b}) may minimize the difference between the corrected waveguide tristimulus transmission and the D65 white, but considering only the chrominance components (O₁, O₂) in the opponent color space, leaving the luminance component L untouched. The system may first calculate the corrected waveguide tristimulus transmission in the opponent color space by applying tentative values of correction factors (tᵣ, t_{g}, t_{b}) to the chrominance components of the waveguide tristimulus transmission in the opponent color space. Then, the system may calculate the difference between the corrected waveguide tristimulus transmission and the target D65 white in the opponent color space. After that, the system may adjust the (tᵣ, t_{g}, t_{b}) values and repeat the above process and compare the resulting difference values. The system may iterate through such optimization process to search for the optimized correction factors (tᵣ, t_{g}, t_{b}) that can minimize the chrominance errors corresponding to the difference between the corrected waveguide tristimulus transmission and the target D65 white in the opponent color space, considering only the chrominance components. In particular embodiments, the system may measure the waveguide transmission characters in the tristimulus space with the native resolution of the display (with the waveguide). Then, the system may convert the waveguide tristimulus transmission into an opponent color space and compute the correction factor values that can minimize the chrominance errors. This may be done for every pixel of the display to generate the correction map. In particular embodiments, the correction map may need to have a same resolution with the images to be displayed, which may be a lower or higher resolution to the native resolution of the display. The system may down sample or up sample the correction map to have an appropriate resolution that matches the images to be displayed.

It is notable that the optimization process in Equation (3) considers only the chrominance errors (corresponding to the O₁ and O₂ components of the opponent color space), leaving the luminance errors (corresponding to the L component of the opponent color space) uncorrected in these image regions. In particular embodiments, the system may correct only the chrominance errors but leave the luminance errors untouched in some image regions because the human vision system is generally more sensitive to the chrominance error (color artifacts) than the luminance errors (brightness non-uniformity). Even the corrected image is not perfect (because it still has the luminance errors), the overall visual effect may be significantly improved by eliminating the chrominance errors and the color related artifacts. Also, it is notable that the visual artifact related to the luminance errors may be limited to the previously discussed uncorrectable image regions (e.g., corner regions that require a maximum to minimum corrector factor ratio beyond 5:1). For the correctable regions (requires a maximum to minimum corrector factor ratio within 5:1, both the chrominance and luminance error may be effectively corrected and eliminated.

In particular embodiments, the system may trade off the corrections for the luminance error and the chrominance error using a weighting parameter in the optimization process. The weighting parameter may weight the luminance component against the chrominance components based on the value of the weighting parameter. For example, the weighting factors may have a value fall within the range from 0 to 1. A greater value for the weighting parameter may allow the system to reduce more the luminance errors (e.g., by a higher degree) and accordingly reduce less the chrominance errors (e.g., by a lower degree) to have more accurate colors. For example, a weighting parameter of 1 may allow the system to minimize the luminance errors to the same extent as to the chrominance errors. On the other hand, a smaller value for the weighting parameters may allow the system to reduce more the chrominance errors and less the luminance error. For example, the weighting parameter value of 0 may allow the system to minimize the chrominance errors, leaving the luminance error untouched. The system may use a second optimization process to determine an optimized weighting parameter value for trading off the luminance and the chrominance errors. Also, the system may incorporate a clipping factor (e.g., a maximum to minimum ratio of 5:1 for the correction factors values in each color channel) by subjecting the optimization process to the pre-determined ranges of: min(tᵣ)<tᵣ<5 min(tᵣ), min(t_{g})<t_{g}<5 min(t_{g}), and min(t_{b})<t_{b}<5 min(t_{b}). In other words, the respective maximum to minimum ratios of the values of the correction factors (tᵣ, t_{g}, t_{b}) may be limited to no more than 5:1. Such a clipping factor may correspond to a maximum to minimum ratio of each color channel as limited by the uLEDs performance. It is notable that the ratio of 5:1 is for example purpose only and the actual ratio is not limited thereof. For example, the ratio may be any suitable number as determined by the display system hardware (e.g., uLEDs).

FIG. 7 illustrates an example optimization process 700 of determining the correction factors by trading off the corrections of the chrominance and luminance errors. To generate the pre-computed correction map or mask, the system may first measure the waveguide transmission characters (X_{rgb}, Y_{rgb}, Z_{rgb}) in the tristimulus space. Then, the system may convert the waveguide tristimulus transmission into an opponent color space (L^{rgb}, O₁^{rgb} O₂^{rgb}). After that, the system may use the optimizer to compute the correction factor values that can minimize the chrominance errors and luminance errors as weighted by a weighting parameter, as shown in the following equation:

$$Minimize ‖ [ \begin{matrix}α {L}^{r} & α {L}^{g} & α {L}^{b} \\ {O}_{1}^{r} & {O}_{1}^{g} & {O}_{1}^{b} \\ {O}_{2}^{r} & {O}_{2}^{g} & {O}_{2}^{b}\end{matrix} ] [ \begin{matrix}{t}_{r} \\ {t}_{g} \\ {t}_{b}\end{matrix} ] - [ \begin{matrix}α {L}^{w} \\ {O}_{1}^{w} \\ {O}_{2}^{w}\end{matrix} ] ‖ \qquad ( 4 )$$

where α is the weighting parameter that trades off the chrominance and luminance error corrections; (L^{r}, O₁^{r}, O₂^{r}) are the components of the opponent color space for the Red color channel; (L^{g}, O₁^{g}, O₂^{g}) are the components of the opponent color space for the Green color channel; (L^{b}, O₁^{b}, O₂^{b}) are the components of the opponent color space for the Blue color channel; (tᵣ, t_{g}, t_{b}) are the correction factors for RGB color channels of a particular pixel of the display; (L^{w}, O₁^{w}, O₂^{w}) are the components of the D65 white in the opponent color space.

In particular embodiments, during the optimization process, the system may use the optimizer as shown in Equation (3) to calculate and optimize the correction factor values (tᵣ, t_{g}, t_{b}). The optimized correction factor values (tᵣ, t_{g}, t_{b}) may minimize the difference between the corrected waveguide tristimulus transmission and the D65 white to reduce both the luminance and chrominance errors as weighted by the weighting parameter α. The system may first calculate the corrected waveguide tristimulus transmission in the opponent color space by applying tentative values of correction factors (tᵣ, t_{g}, t_{b}) to the waveguide tristimulus transmission in the opponent color space. Then, the system may calculate the difference between the corrected waveguide tristimulus transmission and the target D65 white in the opponent color space. After that, the system may adjust the correction factor (tᵣ, t_{g}, t_{b}) values and repeat the above process and compare the resulting difference values. The system may iterate through such optimization process to search for the optimized correction factors (tᵣ, t_{g}, t_{b}) that can minimize the chrominance and luminance errors as weighted by the weighting parameter α. In particular embodiments, the system may measure the waveguide transmission characters in the tristimulus space with the native resolution of the display (with the waveguide). Then, the system may convert the waveguide tristimulus transmission into an opponent color space and compute the correction factor values that can minimize the chrominance and luminance errors as weighted by the weighting parameter. This may be done for every pixel of the display to generate the correction map. In particular embodiments, the correction map may need to have a same resolution with the images to be displayed, which may be a lower or higher resolution to the native resolution of the display. The system may down sample or up sample the correction map to have an appropriate resolution that matches the images to be displayed.

It is notable that the optimization process in Equation (4) considers both the chrominance errors (corresponding to the O₁ and O₂ components of the opponent color space) and the luminance errors (corresponding to the L component of the opponent color space) as weighted by the weighting parameter α. The weighting parameter α may weight the luminance component L^{rgb} against the chrominance components (O₁^{rgb}, O₂^{rgb}) of respective color channels based on the value of the weighting parameter. A greater value for the weighting parameter may allow the system to minimize the luminance errors by a higher degree (and accordingly less chrominance errors are reduced) and thus to have more accurate colors. For example, a weighting parameter of 1 may allow the system to minimize the luminance errors to the same extent as to the chrominance errors. On the other hand, a smaller value for the weighting parameters may allow the system to reduce more chrominance errors and less luminance errors. For example, the weighting parameter value of 0 may allow the system to minimize the chrominance errors, leaving the luminance error untouched. The system may use a second optimization process to determine an optimized weighting parameter value for trading off the luminance and the chrominance errors. In particular embodiments, the weighting parameter may be device specific or/and user specific. The weighting parameter value may be optimized either based on content of display or based on hardware specification.

In some embodiments, each color channel of the RGB color channels may use the same weighting parameter value. For example, as shown in Equation (4), the same weighting parameter α may be used for all three color channels of RGB color channels. To balance the equation, the weighting parameter a may be included in the luminance component of the D65 white αL^{W}. When all three color channels use the same weighting parameter, the optimization target may use the D65 white as a reference color. The corrected color values may be close to their respective ideal target colors as much as the reduced luminance and chrominance errors allow. The balanced luminance and chrominance errors may provide optimized visual results as perceived by the viewer. In particular embodiments, the system may use a second optimization process to determine an optimized weighting parameter value for trading off the luminance and the chrominance errors to achieve the best visual results as perceived by the viewer. For example, the system may try out a number of weighting parameter values to generate the correction maps. Then, the system may display images as corrected using these correction maps to a viewer to obtain feedback from the viewer. The system may repeat this process to determine an optimized weighting parameter value that provides the best visual effect (e.g., the minimum chrominance/luminance errors) as perceived by the viewer. The system may use the optimized weighting parameter to generate the pre-determined correction map. In particular embodiments, the weighting parameter value may be customized for the viewer.

It is notable that when the system corrects the luminance error globally, the weighting factor for the RGB color channels may have the same value, because it affects the relative value of RGB color channels, and the weighting parameter is on both side of the equation. If the system needs to match the displayed white color to the D65 white, the RGB color channels may need to have the same weighting parameter value. However, in particular embodiments, the system may use different values of the weighting parameter for RGB color channels if the displayed colors are allowed to deviate from their respective ideal target color (e.g., displayed white color deviates from the D65 white). In particular embodiments, RGB color channels may use different weighting parameters. By using different weighting parameters for different color channels, the colors of the corrected images may deviate from their respective target colors (e.g., the white color of the displayed image may deviate from the white D65). However, such mechanism may provide a new dimension of flexibility for customizing the correction map and improve the displayed image quality. Even the final corrected images deviate from ideal target colors, such images may be appealing to some viewer's eye and provide better user experience (e.g., colors in the night mode, reduced colorfulness to protect eyes). The system may try out different weighting parameters for generating correction maps and determine the optimized weighting parameters based on the viewer's feedback on the final image results. The final weighting parameters may be customized for and specific to the viewer.

It is notable that the correction factor values may be specific for each pixel of the display or image and the correction factor values may depend on where the corresponding pixel is located (e.g., at the center or edge of the display). For the same reason, the weighting parameter for balancing the luminance error and chrominance error may be customized based on the pixel location. In particular embodiments, the system may use different weighting parameter values for different locations of the display. In other words, the weighting parameter values may be customized based on the location of the associated pixel on the display. For example, for a pixel at an edge of the display, the system may have a smaller weighting parameter value (e.g., closer to 0) to mostly minimize the chrominance errors but leave the luminance errors largely uncorrected. As another example, for a pixel near or at the center area of the display, the system may prioritize the image quality by using a greater weighting parameter value to minimize both the luminance and the chrominance errors. The weighting parameter values that are customized based on the location of the associated pixels may further improve the image quality of the corrected images as perceived by the viewer.

In particular embodiments, to measure the waveguide tristimulus transmission, the system may turn on the Red uLEDs for every pixel of the display and measure the values of (Xᵣ, Yᵣ, Zᵣ). Then, the system may turn on the Green uLEDs for every pixel of the display and measure the values for (Xᵣ, Yᵣ, Zᵣ). Then, the system may turn on the Blue uLEDs for every pixel of the display and measure the values for (Xᵣ, Yᵣ, Zᵣ). In some embodiments, the system may have RGB separatable uLEDs and may turn on each color channel separately. Or, if the system has transmissive LCD display that has color filters built in, the system may use the white light (e.g., turn on the LEDs to generate white light), but only allow the red, green, and blue light to pass each time. Ultimately, the system may measure the RGB color response for each color channel. Then, the system may use the measured results to compute the correction factors values.

In particular embodiments, the system may measure the waveguide transmission characters in the tristimulus space with the native resolution of the display (with the waveguide). Then, the system may convert the waveguide tristimulus transmission into an opponent color space and compute the correction factor values that can minimize the chrominance/luminance errors. This may be done for every pixel of the display to generate the correction map. In particular embodiments, the correction map may need to have a same resolution with the images to be displayed, which may be a lower or higher resolution to the native resolution of the display. The system may down sample or up sample the correction map to have an appropriate resolution that matches the images to be displayed.

In particular embodiments, the color distortions caused by the waveguide non-uniformity may move over the places when the viewer looks through the waveguide at different angles, because the distortion pattern may change with the viewer's eye position or view angle. In particular embodiments, the system may take into consideration of the FOV and the eye box to generate the correction map. An eye box may be an area where the user may move around an eye within the area but can still see the full FOV of the scene. When the viewer's eye moves around within the eye box, the image distortion patterns may be different as perceived by the viewer. Also, the viewer may see through different portions of the waveguide when the viewer's eye position or distance with respect to the waveguide surface changes.

In particular embodiments, the correction map including the corrector factors may be optimized based on the current eye position of the viewer and a number of pre-determined positions associated with an eye box of the viewer. For example, the system may generate correction maps for a number of eye positions within an eye box (e.g., 7×9 eye positions) and store the pre-generated correction maps in a computer storage. At run time, the system may use eye tracking system to track the viewer's eye to determine, for example, the gazing point of the viewer, the eye distance from the waveguide, the view angle of the viewer, the eye positions within the eye box, etc. Then, the system may retrieve the pre-generated correction maps from the computer storage and generate an optimized correction map based on the eye position of the viewer. For example, the system may retrieve a number of pre-generated correction maps corresponding to a number of pre-determined positions (e.g., 4×4 or 2×2) encompassing an area including the viewer's current eye position. Then, the system may generate the optimized correction map by interpolating the pre-generated correction maps based on the viewer's eye position. For example, the correction factor in the optimized correction map may be determined by interpolating corresponding 4×4 or 2×2 correction factors in the corresponding pre-determined correction maps. As such, the system may generate the optimized correction map which have customized correction factors based on one or more of: the viewer's eye position within the eye box, the gazing point of the viewer, the view angle of the viewer, or the eye distance from the waveguide. As an example and not by way of limitation, the embodiments for generating optimized correction maps based on the viewer's eye tracking data are disclosed in U.S. patent application Ser. No. 16/919,025, entitled “Dynamic Uniformity Correction,” filed on 1 Jul. 2020, and issued as U.S. patent Ser. No. 11/410,272 on 9 Aug. 2022, which is incorporated herein by reference.

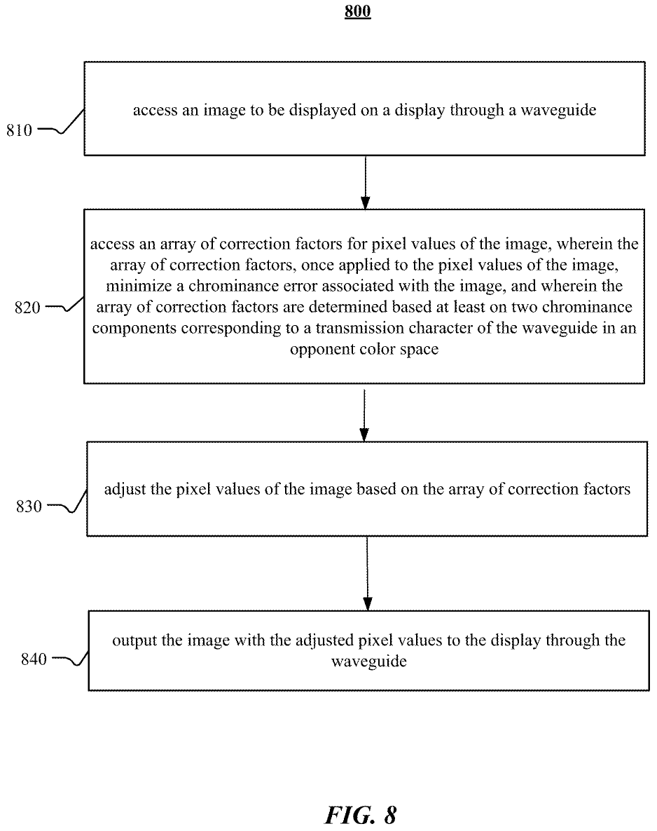

FIG. 8 illustrates an example method 800 for adjusting pixel values of an image based on correction factors to reduce chrominance errors of the image. The method begins at Step 810, wherein a computing system may access an image to be displayed on a display through a waveguide. At Step 820, the system may access an array of correction factors for pixel values of the image. The array of correction factors, once applied to the pixel values of the image, may correct a chrominance error associated with the image. The array of correction factors may be determined based at least on two chrominance components corresponding to a transmission character of the waveguide in an opponent color space. At Step 830, the system may adjust the pixel values of the image based on the array of correction factors. At step 840, the system may output the image with the adjusted pixel values to the display through the waveguide.

In particular embodiments, the array of correction factors may be determined further based on a luminance component corresponding to the transmission character of the waveguide in the opponent color space. In particular embodiments, the array of correction factors once applied to the pixel values of the image may further minimize a luminance error associated with the image. In particular embodiments, the array of correction factors may be determined further based on two or more weighting parameters. Each of the two or more weighting parameters may trade off the luminance component and the two chrominance components of the opponent color space of a particular color channel of RGB color channels. In particular embodiments, the array of correction factors may be determined further based on a weighting parameter that trades off the luminance component and the two chrominance components of the opponent color space.

In particular embodiments, the weighting parameter may equal to zero. The array of correction factors may be determined based on the two chrominance components corresponding to the transmission character of the waveguide in the opponent color space excluding the luminance component corresponding to the transmission character of the waveguide in the opponent color space. In particular embodiments, the weighting parameter may equal to a maximum weighting parameter value (e.g., 1) of a pre-determined value range (e.g., 0 to 1). The two chrominance components of the opponent color space may be weighted equally with respect to the luminance component of the opponent color space. The luminance error may be reduced to a same level as the chrominance error by the array of correction factors.

In particular embodiments, the weighting parameter may have a value greater than zero and smaller than a maximum weighting parameter value of a pre-determined value range. The two chrominance components of the opponent color space and the luminance component of the opponent color space may be weighted proportionally by the weighting parameter. The luminance error and the chrominance error of the image may be reduced proportionally corresponding to the value of the weighting parameter.

In particular embodiments, the weighting parameter may be customized based on a location of an associated pixel on the display. In particular embodiments, the weighting parameter may be shared by three color channels or RGB color channels. In particular embodiments, each of the array of correction factors may correspond to a pixel of the display. In particular embodiments, the array of correction factors may be determined during an optimization process in the opponent color space, and wherein the optimization process uses a D65 white as a reference. In particular embodiments, the optimization process may be subject to a constraint. The constraint may limit a ratio of a maximum correction factor value to a minimum correction facto value to a pre-determined ratio range. The pre-determined ratio range may be determined based a limitation associated an array of uLEDs of the display. In particular embodiments, the array of correction factors may be optimized based on a current eye position with respect to a number of pre-determined eye positions within an eye-box.

Particular embodiments may repeat one or more steps of the method of FIG. 8, where appropriate. Although this disclosure describes and illustrates particular steps of the method of FIG. 8 as occurring in a particular order, this disclosure contemplates any suitable steps of the method of FIG. 8 occurring in any suitable order. Moreover, although this disclosure describes and illustrates an example method for adjusting pixel values of an image based on correction factors to reduce chrominance errors of the image including the particular steps of the method of FIG. 8, this disclosure contemplates any suitable method for adjusting pixel values of an image based on correction factors to reduce chrominance errors of the image including any suitable steps, which may include all, some, or none of the steps of the method of FIG. 8, where appropriate. Furthermore, although this disclosure describes and illustrates particular components, devices, or systems carrying out particular steps of the method of FIG. 8, this disclosure contemplates any suitable combinations of any suitable components, devices, or systems carrying out any suitable steps of the method of FIG. 8.

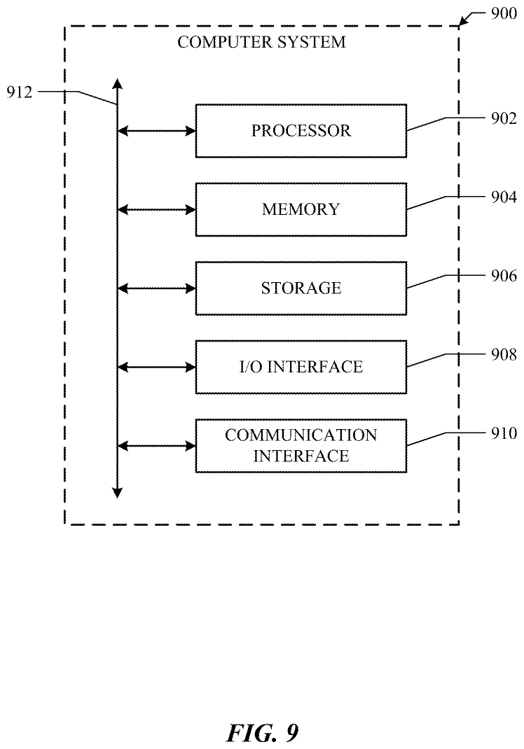

FIG. 9 illustrates an example computer system 900. In particular embodiments, one or more computer systems 900 perform one or more steps of one or more methods described or illustrated herein. In particular embodiments, one or more computer systems 900 provide functionality described or illustrated herein. In particular embodiments, software running on one or more computer systems 900 performs one or more steps of one or more methods described or illustrated herein or provides functionality described or illustrated herein. Particular embodiments include one or more portions of one or more computer systems 900. Herein, reference to a computer system may encompass a computing device, and vice versa, where appropriate. Moreover, reference to a computer system may encompass one or more computer systems, where appropriate.

This disclosure contemplates any suitable number of computer systems 900. This disclosure contemplates computer system 900 taking any suitable physical form. As example and not by way of limitation, computer system 900 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, an augmented/virtual reality device, or a combination of two or more of these. Where appropriate, computer system 900 may include one or more computer systems 900; be unitary or distributed; span multiple locations; span multiple machines; span multiple data centers; or reside in a cloud, which may include one or more cloud components in one or more networks. Where appropriate, one or more computer systems 900 may perform without substantial spatial or temporal limitation one or more steps of one or more methods described or illustrated herein. As an example and not by way of limitation, one or more computer systems 900 may perform in real time or in batch mode one or more steps of one or more methods described or illustrated herein. One or more computer systems 900 may perform at different times or at different locations one or more steps of one or more methods described or illustrated herein, where appropriate.

In particular embodiments, computer system 900 includes a processor 902, memory 904, storage 906, an input/output (I/O) interface 908, a communication interface 910, and a bus 912. Although this disclosure describes and illustrates a particular computer system having a particular number of particular components in a particular arrangement, this disclosure contemplates any suitable computer system having any suitable number of any suitable components in any suitable arrangement.

In particular embodiments, processor 902 includes hardware for executing instructions, such as those making up a computer program. As an example and not by way of limitation, to execute instructions, processor 902 may retrieve (or fetch) the instructions from an internal register, an internal cache, memory 904, or storage 906; decode and execute them; and then write one or more results to an internal register, an internal cache, memory 904, or storage 906. In particular embodiments, processor 902 may include one or more internal caches for data, instructions, or addresses. This disclosure contemplates processor 902 including any suitable number of any suitable internal caches, where appropriate. As an example and not by way of limitation, processor 902 may include one or more instruction caches, one or more data caches, and one or more translation lookaside buffers (TLBs). Instructions in the instruction caches may be copies of instructions in memory 904 or storage 906, and the instruction caches may speed up retrieval of those instructions by processor 902. Data in the data caches may be copies of data in memory 904 or storage 906 for instructions executing at processor 902 to operate on; the results of previous instructions executed at processor 902 for access by subsequent instructions executing at processor 902 or for writing to memory 904 or storage 906; or other suitable data. The data caches may speed up read or write operations by processor 902. The TLBs may speed up virtual-address translation for processor 902. In particular embodiments, processor 902 may include one or more internal registers for data, instructions, or addresses. This disclosure contemplates processor 902 including any suitable number of any suitable internal registers, where appropriate. Where appropriate, processor 902 may include one or more arithmetic logic units (ALUs); be a multi-core processor; or include one or more processors 902. Although this disclosure describes and illustrates a particular processor, this disclosure contemplates any suitable processor.

In particular embodiments, memory 904 includes main memory for storing instructions for processor 902 to execute or data for processor 902 to operate on. As an example and not by way of limitation, computer system 900 may load instructions from storage 906 or another source (such as, for example, another computer system 900) to memory 904. Processor 902 may then load the instructions from memory 904 to an internal register or internal cache. To execute the instructions, processor 902 may retrieve the instructions from the internal register or internal cache and decode them. During or after execution of the instructions, processor 902 may write one or more results (which may be intermediate or final results) to the internal register or internal cache. Processor 902 may then write one or more of those results to memory 904. In particular embodiments, processor 902 executes only instructions in one or more internal registers or internal caches or in memory 904 (as opposed to storage 906 or elsewhere) and operates only on data in one or more internal registers or internal caches or in memory 904 (as opposed to storage 906 or elsewhere). One or more memory buses (which may each include an address bus and a data bus) may couple processor 902 to memory 904. Bus 912 may include one or more memory buses, as described below. In particular embodiments, one or more memory management units (MMUs) reside between processor 902 and memory 904 and facilitate accesses to memory 904 requested by processor 902. In particular embodiments, memory 904 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. This disclosure contemplates any suitable RAM. Memory 904 may include one or more memories 904, where appropriate. Although this disclosure describes and illustrates particular memory, this disclosure contemplates any suitable memory.

In particular embodiments, storage 906 includes mass storage for data or instructions. As an example and not by way of limitation, storage 906 may include a hard disk drive (HDD), a floppy disk drive, flash memory, an optical disc, a magneto-optical disc, magnetic tape, or a Universal Serial Bus (USB) drive or a combination of two or more of these. Storage 906 may include removable or non-removable (or fixed) media, where appropriate. Storage 906 may be internal or external to computer system 900, where appropriate. In particular embodiments, storage 906 is non-volatile, solid-state memory. In particular embodiments, storage 906 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 906 taking any suitable physical form. Storage 906 may include one or more storage control units facilitating communication between processor 902 and storage 906, where appropriate. Where appropriate, storage 906 may include one or more storages 906. Although this disclosure describes and illustrates particular storage, this disclosure contemplates any suitable storage.

In particular embodiments, I/O interface 908 includes hardware, software, or both, providing one or more interfaces for communication between computer system 900 and one or more I/O devices. Computer system 900 may include one or more of these I/O devices, where appropriate. One or more of these I/O devices may enable communication between a person and computer system 900. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 908 for them. Where appropriate, I/O interface 908 may include one or more device or software drivers enabling processor 902 to drive one or more of these I/O devices. I/O interface 908 may include one or more I/O interfaces 908, where appropriate. Although this disclosure describes and illustrates a particular I/O interface, this disclosure contemplates any suitable I/O interface.

In particular embodiments, communication interface 910 includes hardware, software, or both providing one or more interfaces for communication (such as, for example, packet-based communication) between computer system 900 and one or more other computer systems 900 or one or more networks. As an example and not by way of limitation, communication interface 910 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 910 for it. As an example and not by way of limitation, computer system 900 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 900 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 900 may include any suitable communication interface 910 for any of these networks, where appropriate. Communication interface 910 may include one or more communication interfaces 910, where appropriate. Although this disclosure describes and illustrates a particular communication interface, this disclosure contemplates any suitable communication interface.

In particular embodiments, bus 912 includes hardware, software, or both coupling components of computer system 900 to each other. As an example and not by way of limitation, bus 912 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 912 may include one or more buses 912, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising, by a computing system:
accessing an image to be displayed on a display through a waveguide;
accessing an array of correction factors for pixel values of the image, wherein the array of correction factors, once applied to the pixel values of the image, correct a chrominance error associated with the image, and wherein the array of correction factors are determined based at least on two chrominance components corresponding to a transmission character of the waveguide in an opponent color space;
adjusting the pixel values of the image based on the array of correction factors; and
outputting the image with the adjusted pixel values to the display through the waveguide.

2. The method of claim 1, wherein the array of correction factors are determined further based on a luminance component corresponding to the transmission character of the waveguide in the opponent color space.

3. The method of claim 2, wherein the array of correction factors once applied to the pixel values of the image further minimize a luminance error associated with the image.

4. The method of claim 2, wherein the array of correction factors are determined further based on two or more weighting parameters, and wherein each of the two or more weighting parameters trades off the luminance component and the two chrominance components of the opponent color space of a particular color channel of RGB color channels.

5. The method of claim 2, wherein the array of correction factors are determined further based on a weighting parameter that trades off the luminance component and the two chrominance components of the opponent color space.

6. The method of claim 5, wherein the weighting parameter equals to zero, and wherein the array of correction factors are determined based on the two chrominance components corresponding to the transmission character of the waveguide in the opponent color space excluding the luminance component corresponding to the transmission character of the waveguide in the opponent color space.

7. The method of claim 5, wherein the weighting parameter equals to a maximum weighting parameter value of a pre-determined value range, wherein the two chrominance components of the opponent color space are weighted equally with respect to the luminance component of the opponent color space, and wherein the luminance error is reduced to a same level as the chrominance error by the array of correction factors.

8. The method of claim 5, wherein the weighting parameter has a value greater than zero and smaller than a maximum weighting parameter value of a pre-determined value range, wherein the two chrominance components of the opponent color space and the luminance component of the opponent color space are weighted proportionally by the weighting parameter, and wherein the luminance error and the chrominance error of the image are reduced proportionally corresponding to the value of the weighting parameter.

9. The method of claim 5, wherein the weighting parameter is customized based on a location of an associated pixel on the display.

10. The method of claim 5, wherein the weighting parameter is shared by three color channels or RGB color channels.

11. The method of claim 1, wherein each of the array of correction factors corresponds to a pixel of the display.

12. The method of claim 1, wherein the array of correction factors are determined during an optimization process in the opponent color space, and wherein the optimization process uses a D65 white as a reference.

13. The method of claim 12, wherein the optimization process is subject to a constraint, and wherein the constraint limits a ratio of a maximum correction factor value to a minimum correction facto value to a pre-determined ratio range, and wherein the pre-determined ratio range is determined based a limitation associated an array of uLEDs of the display.

14. The method of claim 1, wherein the array of correction factors are optimized based on a current eye position with respect to a plurality of pre-determined eye positions within an eye-box.

15. One or more computer-readable non-transitory storage media embodying software that is operable when executed to:
access an image to be displayed on a display through a waveguide;
access an array of correction factors for pixel values of the image, wherein the array of correction factors, once applied to the pixel values of the image, correct a chrominance error associated with the image, and wherein the array of correction factors are determined based at least on two chrominance components corresponding to a transmission character of the waveguide in an opponent color space;
adjust the pixel values of the image based on the array of correction factors; and
output the image with the adjusted pixel values to the display through the waveguide.

16. The media of claim 15, wherein the array of correction factors are determined further based on a luminance component corresponding to the transmission character of the waveguide in the opponent color space.

17. The media of claim 15, wherein the array of correction factors once applied to the pixel values of the image further minimize a luminance error associated with the image.

18. A system comprising:
one or more non-transitory computer-readable storage media embodying instructions; and
one or more processors coupled to the storage media and operable to execute the instructions to:
access an image to be displayed on a display through a waveguide;
access an array of correction factors for pixel values of the image, wherein the array of correction factors, once applied to the pixel values of the image, correct a chrominance error associated with the image, and wherein the array of correction factors are determined based at least on two chrominance components corresponding to a transmission character of the waveguide in an opponent color space;
adjust the pixel values of the image based on the array of correction factors; and
output the image with the adjusted pixel values to the display through the waveguide.

19. The system of claim 18, wherein the array of correction factors are determined further based on a luminance component corresponding the transmission character of the waveguide in the opponent color space.

20. The system of claim 18, wherein the array of correction factors once applied to the pixel values of the image further minimize a luminance error associated with the image.
